(19) United States
(12) Patent Application Publication
(10) Pub. No.: US 2005/0051000 A1
(43) Pub. Date: Mar. 10, 2005

(54) Fastener gripping tool

(76) Inventors: Ryan McIlvenna, Hanmer (CA); Michael Faubert, Sudbury (CA)

Correspondence Address: Mike M. Gauthier;1264156 Ontario Incorporated, o/a Deviat, 959 Elisabella Street, Unit C, Sudbury, ON, P3A 5K1, CA

(21) Appl. No.: 10/657,225

(22) Filed: Sep. 9, 2003

(51) Int. Cl. B25C 3/00

(52) U.S. Cl. 81/44; 81/418

(57) ABSTRACT

A hand tool for gripping a nail or screws type fastener during the early driving stage. The tool comprises a primary member having a handle, a nail pulling central portion, a pair of gripping ends, and a claw at each said end, a secondary member having a handle, a nail pulling central portion, a central gripping end, and a claw at said end. The primary and secondary members are pivotally engaged at a central region of the tool whereby joining the handles of each member also joins the gripping ends. Each claw further comprises an inner surface having an inwardly tapered opening on the innermost surface of the gripping end joining to a point thereby forming a generally triangular mouth where said mouth in each primary and secondary members is mirror opposite to the other. The user can therefore pick-up a nail or screw with the tool from a hard smooth surface, apply pressure to the fastener and the mouths thereby grip the fastener in a sturdy self-aligning perpendicular fashion so as to hold the fastener while driving said fastener.

### FIELD OF THE INVENTION

The present invention relates to a hand tool for gripping a nail or screws type fastener during the early driving stage. The tool of the present invention comprises; a primary member having a handle, a nail pulling central portion, a pair of gripping ends, and a claw at each said end, a secondary member having a handle, a nail pulling central portion, a central gripping end, and a claw at said end. The primary and secondary members are pivotally engaged at a central region of the tool whereby joining the handles of each member also joins the gripping ends. Each claw further comprises an inner surface having an inwardly tapered opening on the innermost surface of the gripping end joining to a point thereby forming a generally triangular mouth where said mouth in each primary and secondary members is mirror opposite to the other. The user can therefore pick-up a nail or screw with the tool, apply pressure to the fastener and the mouths thereby grip the fastener in a sturdy self-aligning perpendicular fashion so as to hold the fastener while driving said fastener.

### BACKGROUND OF THE INVENTION

For hundreds of years is has been common to use fasteners such as nails and later screws to fasten construction members together. However a common problem occurs to virtually anyone who has used a hammer and nail. That is, users often miss the nail and in a sudden gust of gravity, the hammer strikes a finger or thumb only for the user to continue to risk the very same accident while completing his or her project. Additionally, when using screws, the common problem occurs when starting the thread where it is difficult to maintain a plumb alignment of the screw to the work piece.

It is certainly desirable for persons using a hammer, to avoid such painful mishaps and help those using screws align said screw with the work piece.

The applicant is aware of several attempts in prior art to provide means of gripping nails or the like while driving such fastener. For example, reference may be had to U.S. Pat. No. 3,919,903 of McAlister, issued Nov. 18, 1975, which describes a plier-type tool adapted with two pairs of prongs, which hold a nail on two axes. However, this tool fails on two counts, one, larger nail diameters would be very susceptible to outward slippage and two, the third axis is not secured so the nail could easily tilt to the front of back direction.

Another example of prior art may be had in referring to U.S. Pat. No. 5,829,323 of Liston, issued Nov. 3, 1998, which depicts a nail spike guide and support. This tool was specifically designed for use with spikes and therefore fails to operate on smaller nails and screws

Another example may be had in referring to U.S. Pat. No. 6,098,498 of Ming et al., issued Aug. 8, 2000, which teaches of an accessory guide adapted to frictionally engage to a common pair of pliers so as to provide the user with a guide for starting a nail or screw. This invention does not provide the ability to easily pick up a nail or screw with the tool and does not self adjust for nail diameter variances.

While these and other attempts have been made to provide means for gripping and aligning nails and screws, none of these inventions in prior art singularly or combined are self adjusting for various nail sizes nor do they provide for easy pick up of one nail at a time.

### SUMMARY OF THE INVENTION

It is thus the object of the present invention to provide carpenters and do-it-yourselfers alike means for not only holding a nail or screw, but also to provide means of easily gathering one nail at a time, self adjusting for nail diameter and automatic centering and gripping on three axes.

In one aspect of the invention, there is provided a nail cutter/puller in the body portion of the tool.

In another aspect of the invention, the tool may be fabricated more economically in plastic resin as a gripping tool only with the advantages provided in the nail gripping and picking aspects on the invention.

Accordingly, the device of the present invention provides means for not only holding a nail or screw, but also provides means of easily gathering one nail at a time, self adjusting for nail diameter and automatic centering and gripping on three axes.

The utility of this device includes but is not limited to nails and screws.

### BRIEF DESCRIPTION OF THE DRAWINGS

These and other advantages of the invention will become apparent upon reading the following detailed description and upon referring to the drawings in which:

FIG. 1 is a perspective view from above of the fastener-gripping tool of the present invention shown in use.

FIG. 2 is a perspective view from above of the fastener-gripping tool of the present invention shown in an opened position.

FIG. 3 is a top plan view of the fastener-gripping tool of the present invention shown in an opened position.

FIG. 4 is a left side elevation view of the fastener gripping tool of the present invention shown in a closed position.

FIG. 5 is a top plan view of the fastener-gripping tool of the present invention shown in a closed position.

FIG. 6 is a left side elevation view of the fastener-gripping tool of the present invention shown tilting backwardly.

FIG. 7 is a left side elevation view of the fastener-gripping tool of the present invention shown tilting forwardly.

FIG. 8 is a partial view from above of the gripping end portion of the fastener-gripping tool of the present invention.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

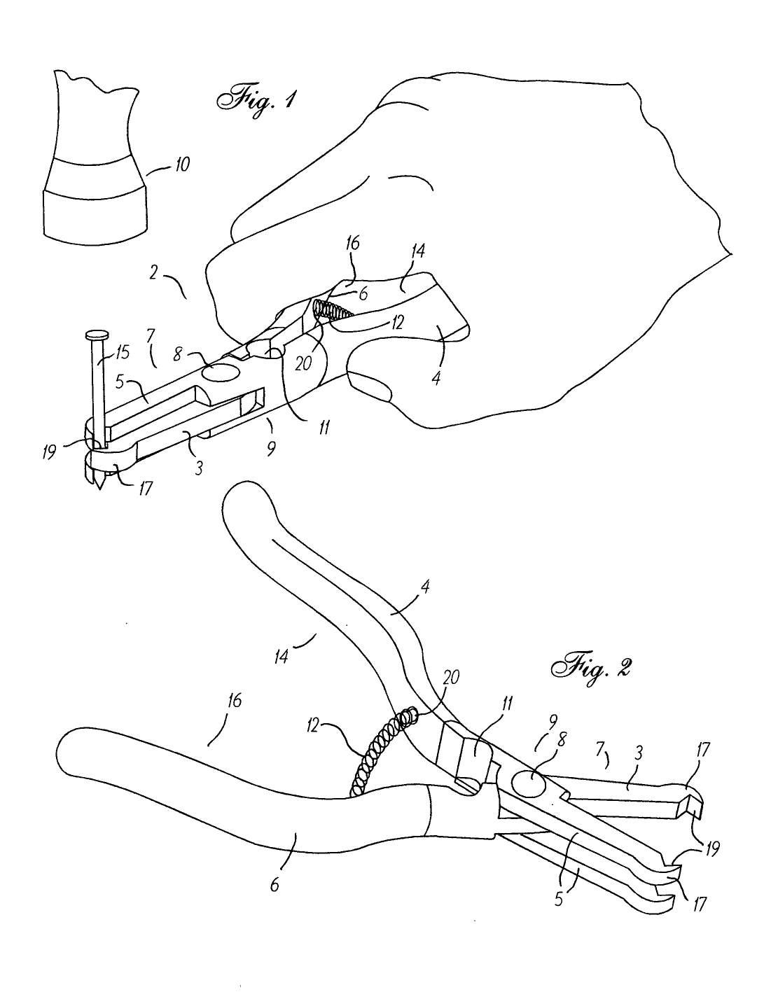

Turning to the drawings, in particular, FIG. 1 which illustrates the fastener gripping tool 2 of the present invention comprising; a primary member 14 having a handle 4, a nail pulling central portion 9, a pair of gripping ends 5, and a claw 17 at each said end 5, a secondary member 16 having a handle 4, a nail pulling central portion 9, a central gripping end 3, and a claw 17 at said end 3. The primary and secondary members 14 and 16 are pivotally engaged at a central region 7 of the tool 2 by means of a fulcrum axle member 8 whereby, joining the handles 4 of each member 14 and 16 also joins the gripping ends 3 and 5. Each claw 17 further comprises an inner surface having an inwardly tapered opening 19 on the innermost surface of the gripping end 3 and 5 tapering to a point thereby forming a generally triangular mouth where said mouth in each primary 14 and secondary 16 member is mirror opposite to the other. The user can therefore pick-up a nail or screw 15 with the tool 2, apply pressure to the fastener 15 and the mouths thereby grip the fastener 15 in a sturdy self-aligning perpendicular fashion so as to hold the fastener 15 while driving said fastener 15 with a hammer 10. The nail pulling/cutting portion 11 comprises: a hemi-cylindrical void along a vertical axis partially through the height of the tool's 2 central region proximal to the handle 4 of each primary 14 and secondary 16 member. A compression spring 12 is provided between the handles 4 proximal to the fulcrum axle 8 so as to promote an opened position for the tool 2. Said spring 12 is frictionally attached to two nipples 20 integrally attached to the inner surfaces of both handle 4 of each primary and secondary members 14 and 16.

Referring now to FIG. 2, a perspective view from above of the fastener gripping tool further illustrating the features of the tool 2 of the present invention wherein, the spring 12 is shown in a more relaxed state frictionally engaged to nipples 20 integrally attached to the inner surfaces of both handles 4 of each primary and secondary members 14 and 16.

Additionally, the nail pulling/cutting feature 11 of the present invention is depicted having a hemi-cylindrical void along a vertical axis partially through the height of the tool's 2 central region proximal to the handle 4 of each primary 14 and secondary 16 member leaving each primary and secondary member's 14 and 16 central region 9 with a half-disk shaped portion adapted to be generally sharp at the region where these half-disks join thereby providing a cutting member when handles 4 are squeezed tightly together.

Furthermore, each primary and secondary member 14 and 16 is adapted with a gripping portion 7 wherein the primary member 14 is further adapted with two gripping member 5 protruding distally from the central region 9 of the tool 2, and the secondary member 16 is further adapted with a single gripping member 3 adapted to slidably and rotably engage between both gripping members 5 of the primary member 14 of the tool 2. Therefore, when the handles 4 are squeezed toward each other, both primary and secondary members 14 and 16 rotate along a common axis 8 thereby rotably joining both primary 5 and secondary 3 gripping members until these members 3 and 5 come to a stop cause by any of three methods; one, by an object such as a nail or screw placed between the gripping members in the gripping region 7, two, by an object such as a nail placed between the tool's 2 cutting edges in the nail pulling/cutting region 11, or three, by the handles 4 coming together as far as the tool with allow without objects there between.

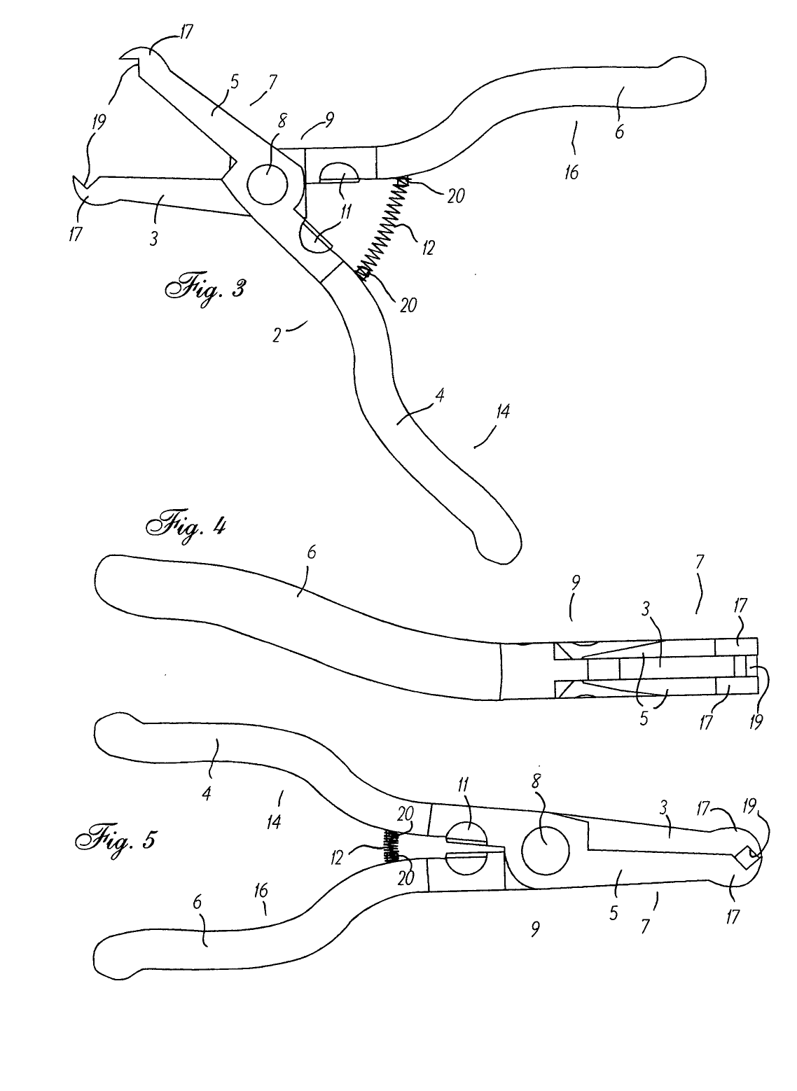

Referring now to FIG. 3, a top plan view of the fastener gripping tool 2 of the present invention illustration in particular the positional relationship between the primary and secondary members 14 and 16 in an opened position.

Turning to FIG. 4, a left side elevation view of the fastener gripping tool of the present invention particularly illustrating the handle portions 4 raise from a surface planar to the central portion 9 and gripping portion 7 thereby allowing the user's fingers sufficient space under the tool's handle portion 4 thus enabling the central 9 and gripping 7 portions to remain level to the work surface in order to position a nail as perpendicularly to said work surface.

In reference now to FIGS. 5, a top plan view of the fastener gripping tool 2 of the present invention illustration in particular the positional relationship between the primary and secondary members 14 and 16 in a closed position.

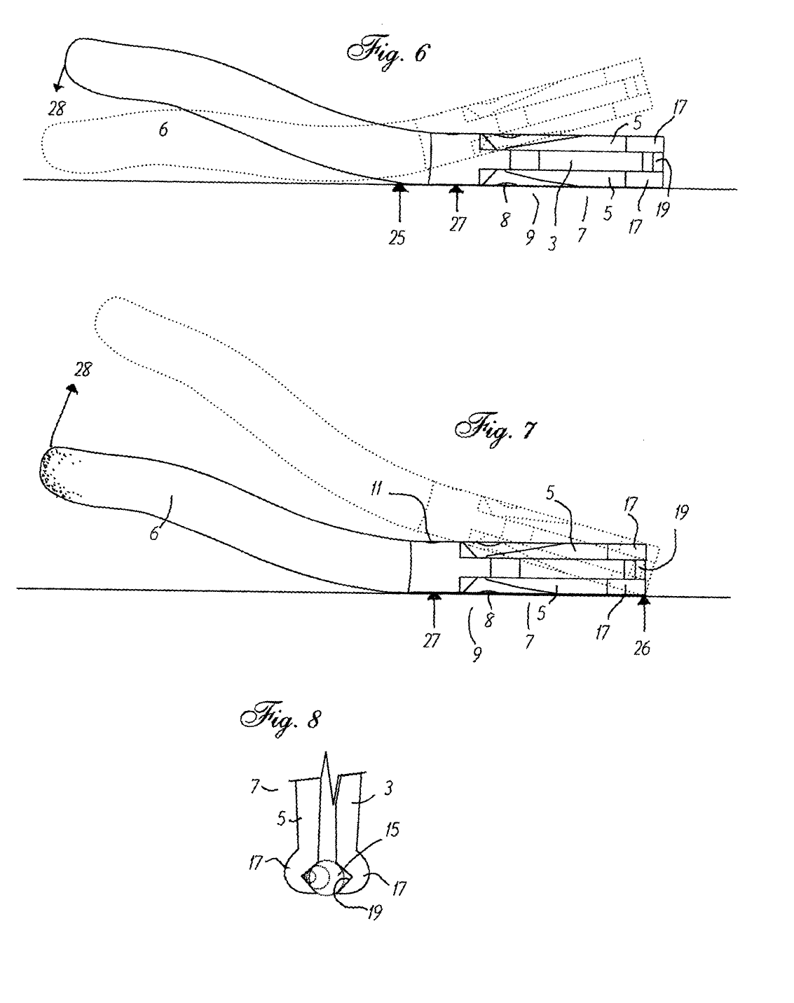

Referring now to FIGS. 6 and 7, both, left-side elevation views of the fastener gripping tool of the present invention illustration the leverage points provided by the tool in nail pulling mode wherein, in FIG. 6, it can be seen that when the user grips a nail in the nail pulling/cutting portion 11 and pushes the handle portion 4 downwardly, the tool provides a greater mechanical advantage as seen in relation to the lever point 28, the fulcrum 25 and the force 27 thereby introducing the required force for the early stage of pulling a nail. Furthermore, once the nail is initially and partially lifted, FIG. 7 illustrates how a lesser mechanical advantage but great pulling distance can complete the nail-pulling action as shown in reference to the lever point 28, the fulcrum 26 and the force 27.

Turning now to FIG. 8, a top plan view of the gripping portion 7 of the fastener gripping tool of the present invention depicting how virtually any diameter nail can be automatically centered within the tapered openings 19 within the claws 17 at the end of each gripping member 3 and 5. Since the recessed portion of the tapered openings 19 rotate on the same orbital plane, and that the claw 17 tips are generally sharp so as to allow easy picking of a nail, even on a hard, planar surface 30.

The embodiments of the invention in which an exclusive property or privilege is claimed are defined as follows:

1. A fastener-gripping tool comprising:
a. a primary and secondary member, both having a handle,
b. a nail pulling central portion,
b. a pair of gripping ends,
c. a claw at each said end,

2. The fastener-gripping tool of claim 1 wherein said primary and secondary members are hinged together at a central area.

3. The fastener-gripping tool of claims 1 and 2 wherein said primary and secondary members are generally mirrored opposites to each other.

4. The fastener-gripping tool of claim 1 further comprising gripping ends at the extremity distal to the handles.

5. The fastener-gripping tool of claim 4 wherein said gripping ends further comprise opposing claws.

6. The fastener-gripping tool of claim 4 wherein the primary member is adapted with one central claw and the secondary members is adapted with two claws, one at either side of the primary member's central claw.

7. The fastener-gripping tool of claim 6 wherein said claws have a triangular opening within the inner surfaces of each claw thereby forming a generally square opening between the claws when viewed from above.

8. The fastener-gripping tool of claims 1, 5, 6 and 7 wherein the claw extremities are pointed generally sharply so as to ease picking up a fastener laid onto a surface.

9. The fastener-gripping tool of claim 1 wherein the use thereof is to gather, hold and align a fastener such as a nail or screw while driving said fastener.
